(19) United States
(12) Patent Application Publication
(10) Pub. No.: US 2025/0384624 A1
(43) Pub. Date: Dec. 18, 2025

(54) DETERMINING A SCALE FACTOR

(71) Applicant: Telefonaktiebolaget LM Ericsson (publ), Stockholm (SE)

(72) Inventors: Elijs DIMA, Upplands Väsby (SE); Volodya GRANCHAROV, Solna (SE)

(73) Assignee: Telefonaktiebolaget LM Ericsson (publ), Stockholm (SE)

(21) Appl. No.: 18/876,910

(22) PCT Filed: Jun. 21, 2022
(86) PCT No.: PCT/EP2022/066846

§ 371 Date: Dec. 19, 2024

(51) Int. Cl. G06T 17/00; G06V 20/17

(52) U.S. Cl. CPC G06T 17/00; G06V 20/17

(57) ABSTRACT

A method (700) of determining a scale factor is provided. The method comprises capturing (s702) a real-world environment using a camera resting on a plane, thereby generating an image. The camera comprises a supporting base including a first reference point. The method further comprises, based on the image, identifying (s704) a first three-dimensional (3D) point of a virtual 3D environment that is a reconstruction of the real-world environment. The first 3D point is mapped to the first reference point of the supporting base. The method further comprises determining (s706) the scale factor based on a coordinate of the first 3D point.

### TECHNICAL FIELD

Disclosed are embodiments related to methods and apparatus for determining a scale factor. The scale factor may be used for calculating real-world dimension(s) of a three-dimensional (3D) reconstructed space.

### BACKGROUND

Today 3D reconstruction of a space is widely used in various fields. For example, for home renovation, one or more 360-degree cameras may be used to capture multiple shots of a kitchen that is to be renovated, and the kitchen may be reconstructed in a 3D virtual space using the captured multiple images. The generated 3D reconstruction of the kitchen can be displayed on a screen and manipulated by a user in order to help the user to visualize how to renovate the kitchen.

### SUMMARY

However, certain challenges exist. For example, in existing solutions, 360-degree cameras alone cannot determine the real-world dimension(s) of a reconstructed 3D space. Multiple shots of 360 camera(s) may be used to estimate a scene geometry of a reconstructed 3D space but the dimensions of the reconstructed 3D space measured by the camera(s) would be in an arbitrary scale. Knowing only the dimension(s) in an arbitrary scale (a.k.a., “relative dimension(s)) may prevent using the estimated scene geometry for measurement purposes and may complicate comparisons and embeddings of multiple separate reconstructions.

Learned depth-prediction methods, such as DEfSI (Depth Estimation from a Single Image) can be used but error in the depth estimation and the overall scale prohibits use of such method in industrial application, where accurate measurement is a must. Thus, there is a need for a way to determine the real-world dimension(s) (a.k.a., “absolute dimension(s)) of the 3D space accurately without using any depth sensors.

Accordingly, in one aspect of some embodiments of this disclosure, there is provided a method of determining a scale factor. The method comprises capturing a real-world environment using a camera resting on a plane, thereby generating an image, wherein the camera comprises a supporting base including a first reference point. The method further comprises, based on the image, identifying a first three-dimensional (3D) point of a virtual 3D environment that is a reconstruction of the real-world environment, wherein the first 3D point is mapped to the first reference point of the supporting base. The method further comprises determining the scale factor based on a coordinate of the first 3D point.

In another aspect, there is provided a computer program comprising instructions which when executed by processing circuitry cause the processing circuitry to perform the method of the embodiments described above.

In a different aspect, there is provided an apparatus for determining a scale factor. The apparatus is configured to capture a real-world environment using a camera resting on a plane, thereby generating an image, wherein the camera comprises a supporting base including a first reference point. The apparatus is further configured to, based on the image, identify a first three-dimensional (3D) point of a virtual 3D environment that is a reconstruction of the real-world environment, wherein the first 3D point is mapped to the first reference point of the supporting base. The apparatus is further configured to determine the scale factor based on a coordinate of the first 3D point.

In a different aspect, there is provided an apparatus comprising a processing circuitry; and a memory. The memory contains instructions executable by said processing circuitry, whereby the apparatus is operative to perform the method of the embodiments described above.

Embodiments of this disclosure allow determining real-world dimension(s) of a reconstructed 3D space without directly measuring the real-world dimension(s) using a depth sensor such as a Light Detection and Ranging (LiDAR) sensor, a stereo camera, or a laser range meter. More specifically, in the embodiments of this disclosure, a scale factor for scaling an arbitrary dimension of a reconstructed 3D space into a real-world dimension of a real-world environment. Furthermore, in the embodiments of this disclosure, the method for determining the scale factor is fully automated, and thus removes human error (e.g., the error of a technician performing any manual measurement).

The accompanying drawings, which are incorporated herein and form part of the specification, illustrate various embodiments.

### BRIEF DESCRIPTION OF THE DRAWINGS

FIG. 1 shows an exemplary scenario where embodiments of this disclosure are implemented.

FIG. 2 shows an example of a captured image.

FIG. 3 shows an exemplary reconstructed 3D space.

FIG. 4 shows a process according to some embodiments.

FIG. 5 shows relationships between various points in a reconstructed 3D space.

FIG. 6 shows a method of calculating a real height value according to some embodiments.

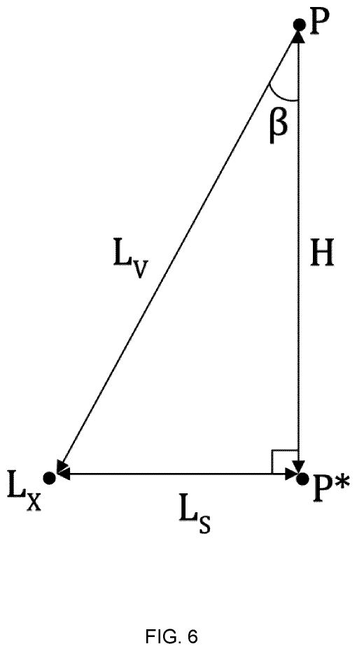

FIG. 7 shows a process according to some embodiments.

FIG. 8 shows an apparatus according to some embodiments.

### DETAILED DESCRIPTION

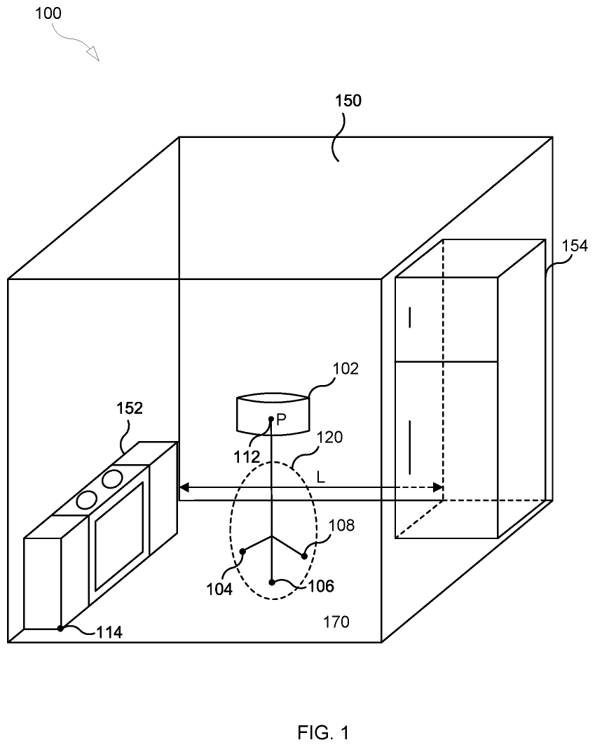

FIG. 1 shows an exemplary scenario 100 where embodiments of this disclosure are implemented. In scenario 100, a 360-degree camera (herein after, “360 camera”) 102 is used to capture a 360-degree view of a kitchen 150. In kitchen 150, there are an oven 152 and a refrigerator 154. In this disclosure, a 360 camera is defined as any camera that is capable of capturing a 360-degree view of a scene. In some embodiments, instead of a 360-degree camera, a non 360-degree camera (e.g., a camera capable of capturing a wide view (but not 360-degree view) of a real-world environment, which includes the view of the base of the camera (e.g., tripod)) can be used. Camera 102 may be a single image capturing unit or may comprise a plurality of image capturing units.

As shown in FIG. 1, camera 102 may include a supporting base 120. One example of supporting base 120 is a tripod including a first reference point 104, a second reference point 106, and a third reference point 108. First, second, and third reference points 104-108 are positioned such that when camera 102 is used for capturing a 360-degree view of kitchen 150, first, second, and third reference points 104-108 are included in the captured image. Even though, in FIG. 1, support base 120 has the form of a tripod, in the embodiments of this disclosure, support base 120 may be any structure that is capable of supporting camera 102 and includes one or more reference points that can be captured by camera 102.

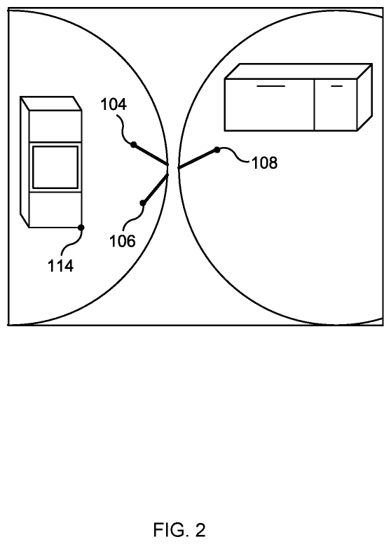

In addition to capturing first, second, and third reference points 104-108, when camera 102 is used for capturing a 360-degree view of kitchen 150, camera 102 may also capture a plurality of points (e.g., 114) on the floor (a.k.a., “floor points”). FIG. 2 shows an example of the 360-degree image captured by camera 102 in scenario 100.

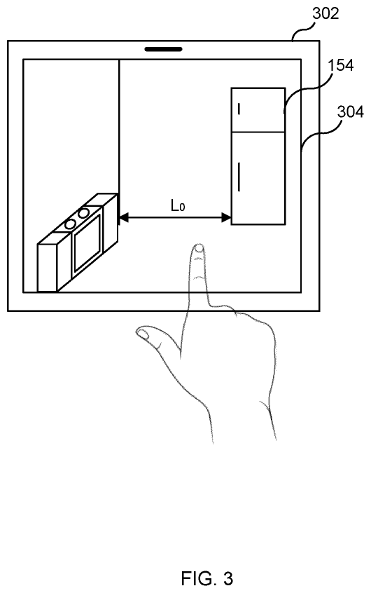

As shown in FIG. 3, the captured 360-degree view of kitchen 150 may be displayed at least partially on a display 304 (e.g., a liquid crystal display, an organic light emitting diode display, etc.) of an electronic device 302 (e.g., a tablet, a mobile phone, a laptop, etc.). Note that even though FIG. 3 shows that only a partial view of kitchen 150 is displayed on display 304, in some embodiments, entire 360-degree view of kitchen 150 may be displayed. Also the curvature of the 360-degree view is not shown in FIG. 3 for simplification purpose.

In some scenarios, it may be desirable to display a real-world length of a virtual dimension (e.g., “L₀”) on display 304 (Note that L₀ shown in FIG. 3 is a length of the dimension in an arbitrary scale). For example, in order to help a user to determine whether a particular kitchen sink will fit into the space between a wall and a left side of refrigerator 154, it may be desirable to show the real-world length of the virtual dimension L₀ on display 304. However, as discussed above, in existing solutions, a real-world length of a dimension of a reconstructed 3D space cannot be accurately measured or determined by 360 camera(s) alone.

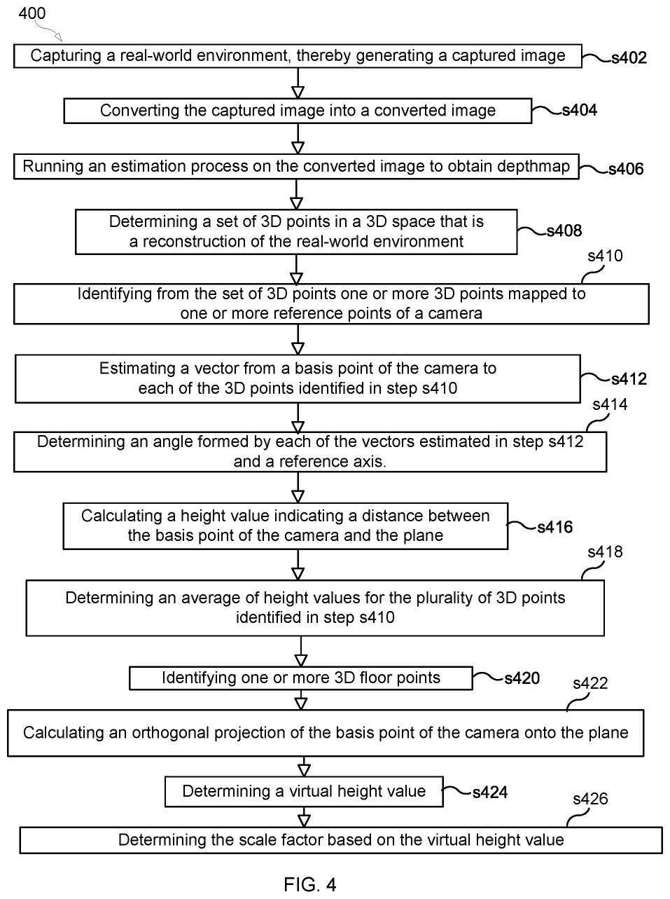

Accordingly, in some embodiments of this disclosure, a process 400 shown in FIG. 4 is performed, in order to determine a scale factor. The scale factor can be used to convert virtual dimension(s) (e.g., “L₀” shown in FIG. 3) of a 3D space (which is a reconstruction of a real-world environment) into real-world dimension(s) (e.g., “L” shown in FIG. 1) of the real-world environment. For example, L may be equal to L₀×the scale factor or L₀/the scale factor. Process 400 may begin with step s402.

Step s402 comprises capturing a real-world environment (e.g., kitchen 150 shown in FIG. 1) using camera 102, thereby obtaining a captured image. In one embodiment, camera 102 includes a fisheye lens, and thus the captured image is a fisheye image IF. For the purpose of simple explanation, the captured image will be referred as the fisheye image IF.

Step s404 comprises converting the fisheye image IF into a converted image (e.g., an equirectangular image I_{EQN}). For the purpose of simple explanation, the converted image will be referred as the equirectangular image I_{EQN}. The concept of a fisheye image, an equirectangular image, and converting a fisheye image into an equirectangular image is well known in the art, and thus are not explained in detail in this disclosure.

Step s406 comprises running a single-shot deep-learning depth estimation process such as Deep Learning Based Epidemic Forecasting with Synthetic Information (DEfSI described in https://github.com/niranjan-v/Depth-Estimation-from-Single-Image) on the equirectangular image in order to obtain depth map of the image. As known in the art, depth map of an image is an array of depth values indicating a 3D depth of each point in the image with respect to a reference point in a 3D environment.

Step s408 comprises determining a set of 3D points in a 3D space that is a reconstruction of the real-world environment (e.g., kitchen 150). In this disclosure, a 3D point is a point defined in a coordinate system of a virtual 3D space. Here, in the coordinate system of the virtual 3D space, a basis point 112 of camera 102 may be set as the origin. One example of basis point 112 is a center point of camera 102. In other words, the coordinates of the 3D points may be defined with respect to basis point 112 of camera 102. The set of 3D points is also referred as a point cloud in this disclosure.

Step s410 comprises identifying from the set of 3D points one or more 3D points mapped to the reference points of supporting base 120 of camera 102. For example, step s410 comprises identifying first, second, and third reference points 104-108.

In performing step s410, in some embodiments, segmentation/growing described in https://docs.opencv.org/4.x/d3/db4/tutorial_py_watershed.html may be used to isolate the region showing portion(s) of the body of camera 102 (e.g., the tip points of the tripod of camera 102) in I_{EQN}.

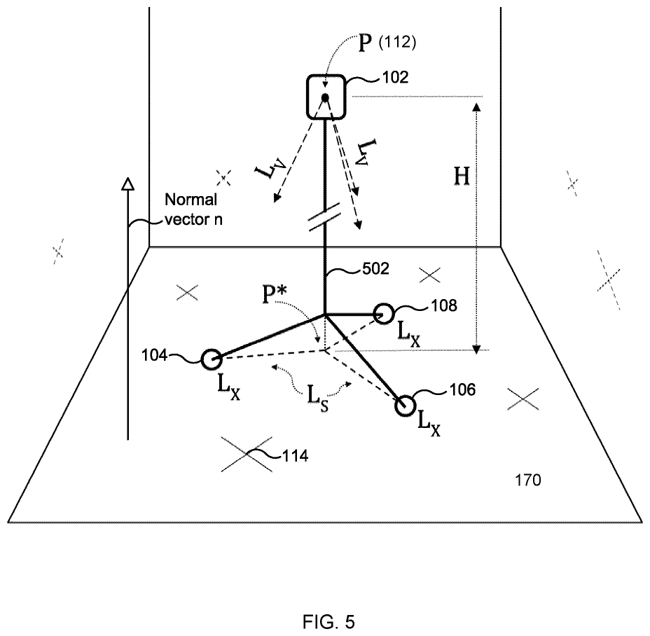

Step s412 comprises estimating a directional vector from basis point 112 of camera 102 to each of the 3D points identified in step s410 (e.g., first, second, and third reference points 104-108). The pixel coordinates of each of the 3D points in I_{EQN} correspond to longitude and latitude angles, which form the directional vector L_{V}, as shown in FIG. 5.

Step s414 comprises determining an angle formed by each of the directional vectors estimated in step s412 with respect to a reference axis (e.g., 502 shown in FIG. 5).

Step s416 comprises calculating a height value (a.k.a., a first distance value) indicating a distance between basis point 112 of camera 102 and plane 170 on which basis point 112 of camera 102 are rested, based on the angle determined in step s414 and a predefined distance. In some embodiments, the predefined distance may be Ls shown in FIG. 5, which indicates a distance between a point projected from basis point 112 of camera 102 to plane 170 and one of the 3D points identified in step s410. In some embodiments.

$$H = \frac{{L}_{S}}{tan ( β )} ,$$

where H is the heigh value, Ls is the predefined distance, and β is the angle determined in step s414.

In case more than one 3D point is identified in step s410, performing steps s412-416 for each of the identified 3D points would result in multiple height values. In such case, step s418 may be performed. Step s418 comprises determining an average of the height values obtained in step s416. The average of the height values corresponds to an actual physical distance between camera 102 and plane 170.

Step s420 comprises, using the captured image (e.g., I_{EQN}), identifying one or more 3D floor points. Here a 3D floor point is a virtual 3D point lying on a plane (e.g., plane 170). One example of the 3D floor point is a point 114 shown in FIGS. 1 and 5.

Step s422 comprises, calculating an orthogonal projection P* of basis point 112 (P) of camera 102 onto plane 170 using the coordinate of the 3D floor point, the coordinate of basis point 112, and a normal vector of plane 170. As shown in FIG. 5, the orthogonal projection is an intersection point of reference axis 502 and plane 170. In some embodiments, the coordinate of the intersection point P* may be calculated as follows: P*=P−(n·(P−O)) n, where P* is the coordinate of intersection point P*, P is the coordinate of basis point 112 of camera 102, O is the coordinate of 3D floor point 114, and n is a normal vector of the plane.

Step s424 comprises determining a virtual height value (a.k.a., a second distance value) indicating a distance between reference point P of camera 102 and intersection point P* in the virtual 3D space. In other words, the virtual height value indicates a height level of camera 102 in the virtual 3D space.

Step s426 comprises determining the scale factor that transforms the virtual height value into the real height value, based on the virtual height value and the real height value. For example the scale factor may be calculated as follows:

$$S = \frac{{H}_{in}}{{H}_{avg}} or \frac{{H}_{avg}}{{H}_{in}} ,$$

where S is the scale factor, Hᵢₙ is virtual height value, and H_{avg} is the actual height value.

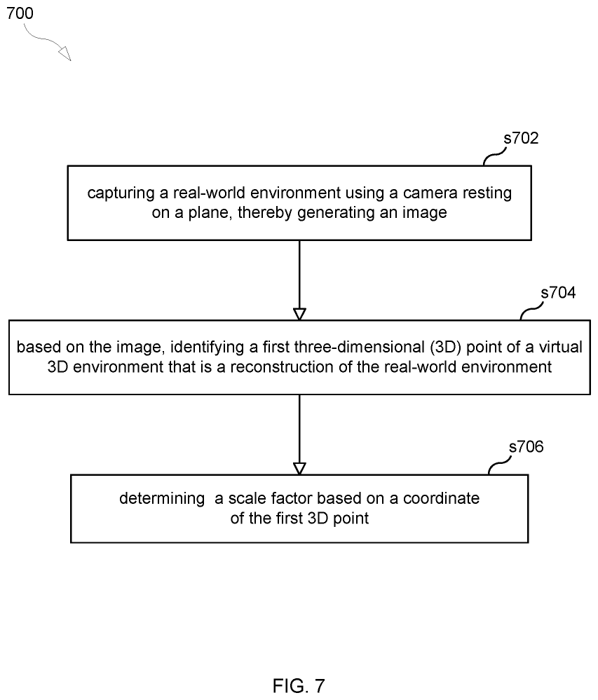

FIG. 7 shows a process 700 for determining a scale factor, according to some embodiments. Process 700 may begin with steps 702. Step s702 comprises capturing a real-world environment using a camera resting on a plane, thereby generating an image, wherein the camera comprises a supporting base including a first reference point. Step s704 comprises, based on the image, identifying a first three-dimensional (3D) point of a virtual 3D environment that is a reconstruction of the real-world environment, wherein the first 3D point is mapped to the first reference point of the supporting base. Step s706 comprises determining the scale factor based on a coordinate of the first 3D point.

In some embodiments, the supporting base is a tripod, and the first reference point is a tip of the tripod.

In some embodiments, the method further comprises based on the coordinate of the first 3D point, calculating a first distance value indicating a real-world distance between the camera and the plane; and calculating a second distance value indicating a virtual distance between the camera and the plane, wherein the scale factor is determined based on the first and second distance values.

In some embodiments, the method further comprises determining a first directional vector between the first 3D point and the camera; and determining an angle value indicating an angle formed by the first directional vector with respect to a reference axis, wherein the first distance value is calculated using the angle value, and the reference axis is perpendicular to the plane.

In some embodiments, the first distance value is calculated using the angle value and a third distance value, and the third distance value indicates a real-world distance between the first reference point of the supporting base and an intersection point of the reference axis and the plane.

In some embodiments,

$$H = \frac{{L}_{S}}{tan ( β )} ,$$

where H is the first distance value, Ls is the third distance value, and β is the angle value.

In some embodiments, the method comprises based on the image, identifying a 3D floor point on the plane; and determining a coordinate of an intersection point of a reference axis and the plane based on a coordinate of the 3D floor point and a coordinate of a basis point of the camera, wherein the second distance value is calculated based on the coordinate of the intersection point and the coordinate of the basis point of the camera.

In some embodiments, P*=P−(n·(P−O)) n, where P* is the coordinate of the intersection point, P is the coordinate of the basis point of the camera, O is the coordinate of the 3D floor point, and n is a normal vector of the plane.

In some embodiments, the supporting base comprises a plurality of reference points including the first reference point, and the method further comprises: based on the image, identifying a plurality of 3D points of the virtual 3D environment, wherein each of the plurality of 3D points is mapped to each of the plurality of reference points; and determining the scale factor based on coordinates of the plurality of 3D points.

In some embodiments, the method further comprises determining a directional vector between each of the plurality of 3D points and a virtual basis point of the camera; determining an angle value indicating an angle formed by each of the determined directional vectors with respect to a reference axis; and calculating a plurality of distance values using the determined angle values and one or more reference distance values, wherein said one or more reference distance values indicate a reference distance between each of the plurality of reference points of the supporting base and an intersection point of the reference axis and the plane within the real-environment, and the scale factor is determined based on an average of the plurality of distance values.

In some embodiments,

$$S = \frac{{H}_{in}}{{H}_{avg}} or \frac{{H}_{avg}}{{H}_{in}} ,$$

where S is the scale factor, Hᵢₙ is the second distance value, and H_{avg} is the average of the plurality of distance values.

In some embodiments, the scale factor is for determining a real-world dimension of an item included in the real-world environment.

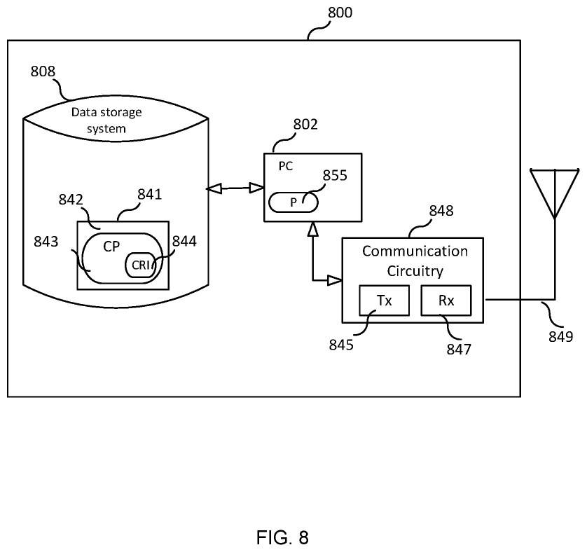

FIG. 8 shows an apparatus (e.g., a server, a mobile phone, a smartphone, a tablet, a laptop, a desktop, etc.) capable of performing all steps included in process 400 (shown in FIG. 4) or at least some of the steps included in process 400 (shown in FIG. 4). As shown in FIG. 8, the apparatus may comprise: processing circuitry (PC) 802, which may include one or more processors (P) 855 (e.g., one or more general purpose microprocessors and/or one or more other processors, such as an application specific integrated circuit (ASIC), field-programmable gate arrays (FPGAs), and the like); communication circuitry 848, which is coupled to an antenna arrangement 849 comprising one or more antennas and which comprises a transmitter (Tx) 845 and a receiver (Rx) 847 for enabling the apparatus to transmit data and receive data (e.g., wirelessly transmit/receive data); and a local storage unit (a.k.a., “data storage system”) 808, which may include one or more non-volatile storage devices and/or one or more volatile storage devices. In some embodiments, the apparatus may not include the antenna arrangement 849 but instead may include a connection arrangement needed for sending and/or receiving data using a wired connection. In embodiments where PC 802 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes the apparatus to perform steps described herein (e.g., steps described herein with reference to the flow charts). In other embodiments, the apparatus may be configured to perform steps described herein without the need for code. That is, for example, PC 802 may consist merely of one or more ASICs. Hence, the features of the embodiments described herein may be implemented in hardware and/or software.

1. A method of determining a scale factor, the method comprising:
capturing a real-world environment using a camera resting on a plane, thereby generating an image, wherein the camera comprises a supporting base including a first reference point;
based on the image, identifying a first three-dimensional (3D) point of a virtual 3D environment that is a reconstruction of the real-world environment, wherein the first 3D point is mapped to the first reference point of the supporting base; and
determining the scale factor based on a coordinate of the first 3D point.

2. The method of claim 1, wherein
the supporting base is a tripod, and
the first reference point is a tip of the tripod.

3. The method of claim 1, wherein the method further comprises:
based on the coordinate of the first 3D point, calculating a first distance value indicating a real-world distance between the camera and the plane; and
calculating a second distance value indicating a virtual distance between the camera and the plane, wherein
the scale factor is determined based on the first and second distance values.

4. The method of claim 3, wherein the method further comprises:
determining a first directional vector between the first 3D point and the camera; and
determining an angle value indicating an angle formed by the first directional vector with respect to a reference axis, wherein
the first distance value is calculated using the angle value, and
the reference axis is perpendicular to the plane.

5. The method of claim 4, wherein
the first distance value is calculated using the angle value and a third distance value, and
the third distance value indicates a real-world distance between the first reference point of the supporting base and an intersection point of the reference axis and the plane.

6. The method of claim 5, wherein
$$H = \frac{{L}_{S}}{tan ( β )} ,$$
where H is the first distance value, Ls is the third distance value, and β is the angle value.

7. The method of claim 3, wherein the method further comprises:
based on the image, identifying a 3D floor point on the plane; and
determining a coordinate of an intersection point of a reference axis and the plane based on a coordinate of the 3D floor point and a coordinate of a basis point of the camera, wherein the second distance value is calculated based on the coordinate of the intersection point and the coordinate of the basis point of the camera.

8. The method of claim 7, wherein P*=P−(n·(P−O)) n, where P* is the coordinate of the intersection point, P is the coordinate of the basis point of the camera, O is the coordinate of the 3D floor point, and n is a normal vector of the plane.

9. The method of of claim 1, wherein
the supporting base comprises a plurality of reference points including the first reference point, and
the method further comprises:
based on the image, identifying a plurality of 3D points of the virtual 3D environment, wherein each of the plurality of 3D points is mapped to each of the plurality of reference points; and
determining the scale factor based on coordinates of the plurality of 3D points.

10. The method of claim 9, wherein the method further comprises:
determining a directional vector between each of the plurality of 3D points and a virtual basis point of the camera;
determining an angle value indicating an angle formed by each of the determined directional vectors with respect to a reference axis; and
calculating a plurality of distance values using the determined angle values and one or more reference distance values, wherein
said one or more reference distance values indicate a reference distance between each of the plurality of reference points of the supporting base and an intersection point of the reference axis and the plane within the real-environment, and
the scale factor is determined based on an average of the plurality of distance values.

11. The method of claim 10, wherein
$$S = \frac{{H}_{in}}{{H}_{avg}} or \frac{{H}_{avg}}{{H}_{in}} ,$$
where S is the scale factor, Hᵢₙ is the second distance value, and H_{avg} is the average of the plurality of distance values.

12. The method of of claim 1, wherein the scale factor is for determining a real-world dimension of an item included in the real-world environment.

13. A non-transitory computer readable storage medium storing a computer program comprising instructions for configuring an apparatus to perform the method of claim 1.

14. (canceled)

15. An apparatus for determining a scale factor, the apparatus comprising:
a processing circuitry; and
a memory storing instructions executable by the processing circuitry, wherein the apparatus is configured to perform a method comprising:
capturing a real-world environment using a camera resting on a plane, thereby generating an image, wherein the camera comprises a supporting base including a first reference point;
based on the image, identifying a first three-dimensional (3D) point of a virtual 3D environment that is a reconstruction of the real-world environment, wherein the first 3D point is mapped to the first reference point of the supporting base; and
determining the scale factor based on a coordinate of the first 3D point.

16. The apparatus of claim 15, wherein
the supporting base is a tripod, and
the first reference point is a tip of the tripod.

17. The apparatus of claim 15, wherein the method further comprises:
based on the coordinate of the first 3D point, calculating a first distance value indicating a real-world distance between the camera and the plane; and
calculating a second distance value indicating a virtual distance between the camera and the plane, wherein
the scale factor is determined based on the first and second distance values.

18. The apparatus of claim 17, wherein the method further comprises:
determining a first directional vector between the first 3D point and the camera; and
determining an angle value indicating an angle formed by the first directional vector with respect to a reference axis, wherein
the first distance value is calculated using the angle value, and
the reference axis is perpendicular to the plane.

19. The apparatus of claim 18, wherein
the first distance value is calculated using the angle value and a third distance value, and
the third distance value indicates a real-world distance between the first reference point of the supporting base and an intersection point of the reference axis and the plane.

20. The apparatus of claim 19, wherein
$$H = \frac{{L}_{S}}{tan ( β )} ,$$
where H is the first distance value, Ls is the third distance value, and β is the angle value.

21. The apparatus of claim 17, wherein the method further comprises:
based on the image, identifying a 3D floor point on the plane; and
determining a coordinate of an intersection point of a reference axis and the plane based on a coordinate of the 3D floor point and a coordinate of a basis point of the camera, wherein the second distance value is calculated based on the coordinate of the intersection point and the coordinate of the basis point of the camera.

22-27. (canceled)
